(19) United States
(12) Patent Application Publication
(10) Pub. No.: US 2013/0290063 A1
(43) Pub. Date: Oct. 31, 2013

(54) Optimizing Allocations In A Workforce Allocation Plan

(71) Applicants: Maria Teresa Gonzalez Diaz, Mountain View, CA (US); Cipriano A. Santos, Modesto, CA (US); Kay-Yui Chen, Santa Clara, CA (US); Marcos César Vargas-Magaña, San Pedro Zacatenco (MX); Carlos Enrique Valencia Oleta, Tlalpan (MX)

(72) Inventors: Maria Teresa Gonzalez Diaz, Mountain View, CA (US); Cipriano A. Santos, Modesto, CA (US); Kay-Yui Chen, Santa Clara, CA (US); Marcos César Vargas-Magaña, San Pedro Zacatenco (MX); Carlos Enrique Valencia Oleta, Tlalpan (MX)

(21) Appl. No.: 13/457,570

(22) Filed: Apr. 27, 2012

(51) Int. Cl. G06Q 10/06

(52) U.S. Cl. 705/7.25

(57) ABSTRACT

A method for optimizing allocations in a workforce allocation plan begins when resource data is received. The resource data includes data that relates to employee resources and to demand for the employee resources. A first set of employee resource pairings is established using the user's resource preferences to assigning the employee resources to the demand for the employee resources. A second set of employee resource pairings is established using predetermined resource preferences to assign the employee resources to the demand for the employee resources. The second set of employee resource pairings includes all employee resource pairings that belong to an optimal solution. The first and second sets of employee resource pairings are compared to provide the workforce allocation plan having the optimal solution with the maximum number of the user's resource preferences to optimize allocations in the workforce allocation plan.

### BACKGROUND

Business organizations with a large number of employees may engage in workforce resource or allocation planning, such as to ensure adequate staffing and to increase the efficiency of workforce allocation among various projects undertaken by the organization. One approach to workforce allocation planning involves a manual process in which a user or manager makes their own determinations as to which of their resources or employees are best suited to perform a particular task or demand. Employees are simply assigned tasks using individual judgment and subjective information, thus resulting in suboptimal solutions.

In an effort to efficiently utilize the available workforce and to improve employee and customer satisfaction, many companies invest significant amounts of time and money in workforce optimization solutions. Such solutions often use a mathematical model to represent the resources of the company and the demand for those resources. By solving such a model in a manner that optimizes one or more variables, the company may determine a plan for assigning employees or resources to particular tasks or demands.

### DESCRIPTION OF THE DRAWINGS

FIG. 1 illustrates a block diagram of an embodiment of a workforce allocation system including a machine-readable storage medium encoded with instructions for optimizing a workforce allocation plan based on a set of resource data.

FIG. 2 illustrates an embodiment for a method for capturing a user's resource preferences in a resource/position (RP) optimization engine.

FIG. 3 illustrates an embodiment for a method for capturing a user's resource preferences in the RP optimization engine.

FIG. 4a is a bipartite graph illustrating a first set of employee resource pairings having a user's resource or pre-allocation preferences for allocating employee resources to demands for the employee resources.

FIG. 4b is a bipartite graph illustrating a second set of employee resource pairings having predetermined resource preferences for optimizing allocations of employee resources to demands for the employee resources, with each of the resource pairings belonging to an optimal solution.

FIG. 4c is a bipartite graph illustrating the workforce allocation plan of a minimum cost having the optimal solution with the maximum number the user's resource preferences.

FIG. 5 illustrates an embodiment for a method of optimizing allocations in a workforce allocation.

### DETAILED DESCRIPTION

A workforce allocation plan is associated with resource data that includes data that represents employee resources available to an organization, as well as data associated with a set of opportunities that each represents a demand for the employee resources. A workforce allocation plan may be generated, for example, by any appropriate computational method. A workforce allocation plan may be generated by a workforce allocation planning tool or system, the functionality of which may be embodied in executable code in a computer readable medium. The objective function may include optimizing a tradeoff between predetermined resource preferences, as determined by a set of constraints and variables associated with a particular task or demand, and a user's resource preferences for assigning employee resources to a set of opportunities that represent the demand for the employee resources. Further, the computational method used to generate the workforce allocation plan may be configurable, such that one or more mathematical models used in the generation of the plan may be optimized, for example in light of an evaluation performed on the workforce allocation plan. The workforce allocation plan may include a workforce allocation plan that maps employees to tasks or demands associated with one or more opportunities. For example, a workforce allocation plan may favor minimizing workforce cost to total demand fulfillment.

One method to optimize allocations in a workforce allocation plan uses a program having executable computer-readable instructions that factors in subjective information from a user in the form of a user's resource preferences. In the example, a user may represent any one that could provide input in the form of the user's resource preferences or pre-allocation preferences, for example, the user may be a manager or management at a business or organization.

In an example method, resource data is received. The resource data includes data that relates to employee resources and to a set of opportunities that represent the demand for the employee resources. A first set of employee resource pairings is established using the user's resource preferences to assign the employee resources to the set of opportunities that represent the demand for the employee resources. In the example, a user's resource preferences or pre-allocation preferences, are the employee resources a user or manager would prefer to be assigned to a task or demand for the employee resource. A second set of employee resource pairings is established using predetermined resource preferences to assign the employee resources to the set of opportunities that represent the demand for the employee resources. The predetermined resource preferences may be based on various business rules or constraints captured in an objective function. Variables associated with the predetermined resource preferences may be restricted by constraints that may be equalities or inequalities that the variables have to satisfy. The second set of all employee resource pairings further defines each of the employee resource pairings that belong to an optimal solution as determined by a mathematical model. The first and second sets of employee resource pairings are compared to provide the workforce allocation plan having the optimal solution with the maximum number of the user's resource preferences to optimize allocations in the workforce allocation plan. As such, the workforce allocation plan allows for an optimal solution that factors in allowable user's resource preferences.

The optimization process for the workforce allocation plan assigns employees to a particular task by factoring in a user's resource preferences to optimize workforce allocations in resource planning. The optimization process factors in not only the resources available and the cost associated with each resource performing a particular task, but may include subjective input from a user or management as to what resources are preferred to perform a particular task or demand.

The example may use a mathematical model to produce the first set of employee resource pairings, in the form of a first biparite graph showing all the tasks a particular employee could be assigned, that takes into account the user's resource preferences. The mathematical model further produces the second set of employee resource pairings, in the form of a second biparite graph showing all the tasks a particular employee could be assigned, that takes into account the predetermined resource preferences that belong each of the potential optimal solutions. The workforce allocation plan is generated, taking into account the first and second sets of employee resource pairings from the first and second bipartite graphs, to develop the workforce allocation plan that includes the optimal solution with the maximum number of the user's resource preferences. That is, the workforce allocation plan includes the maximum number of the user's resource preferences to optimize allocations in the workforce allocation plan.

A system of optimizing allocations in a workforce allocation plan by factoring in a user's resource preference may include a data storage subsystem to store a dataset including resource data having data that relates to employee resources and data that relates to a set of opportunities that represents demand for the employee resources. The system may further include a processing subsystem in communication with the data storage subsystem to perform the method of optimizing allocations in a workforce allocation plan described herein.

These principles are discussed herein with respect to example processes, methods, system, and apparatus, and with reference to various diagrams. The example embodiments are shown and described as a series of blocks, but are not limited by this depiction, as the actions, steps, concepts, and principles associated with the illustrated blocks may occur in different orders than as described, and/or concurrently, and fewer or more than the illustrated number of blocks may be used to implement an example method. Blocks may be combined or include multiple components or steps.

Also, many of the functional units described herein as steps, methods, processes, systems, subsystems, routines, modules, executors, data transformers, and so forth, may be implemented by one or more processors executing software. Executable code may include physical and/or logical blocks of computer instructions that may be organized as a procedure, function, and so forth. The executables associated with an identified process or method need not be physically collocated, but may include disparate instructions stored in different locations which, when joined together, collectively perform the method and/or achieve the purpose thereof. Executable code may be a single instruction or many, may be distributed across several different code segments, among different programs, across several memory devices, and so forth. Methods may be implemented on a computer, with the term “computer” referring herein to one or more computers and/or a computer network, or otherwise in hardware, a combination of hardware and software, and so forth.

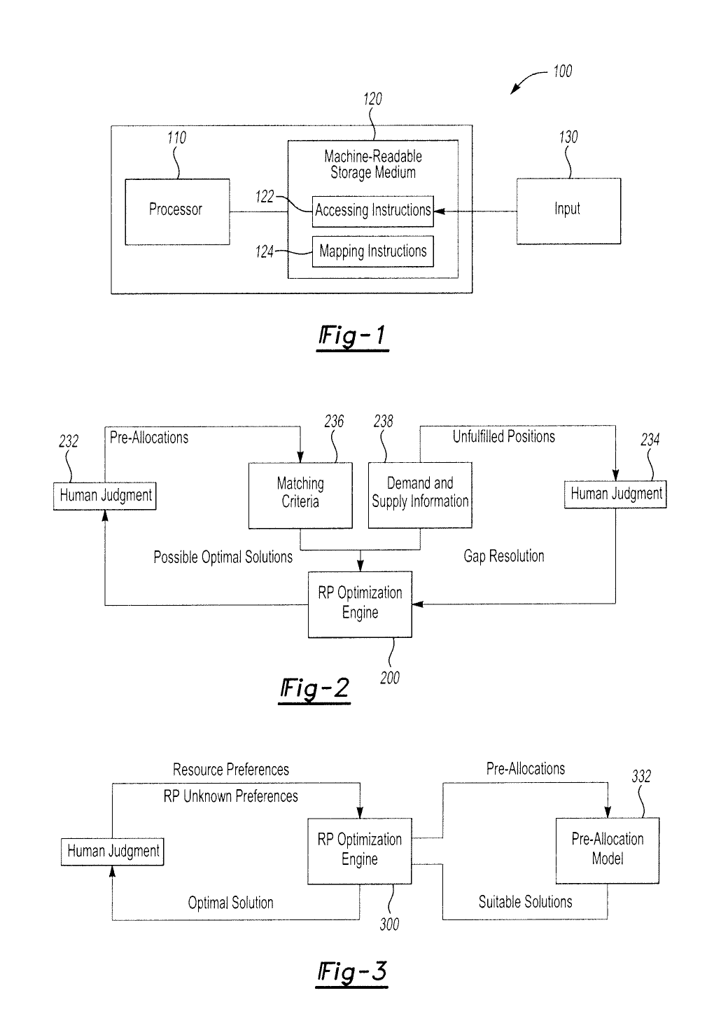

Referring now to the drawings, FIG. 1 illustrates a block diagram of an example of a workforce allocation system 100 including a machine-readable storage medium 120 encoded with instructions to optimize a workforce allocation plan or model. The workforce allocation system 100 may be, for example, a desktop computer, a laptop computer, a server, a supercomputer, or any other hardware device suitable for execution of the instructions and processes described in detail below. In the embodiment of FIG. 1, the workforce allocation system 100 includes a processor 110 and a machine-readable storage medium 120.

The processor 110 may be a central processing unit (CPU), a semiconductor-based microprocessor, or any other hardware device suitable for retrieval and execution of instructions stored in the machine-readable storage medium 120. The machine-readable storage medium 120 may be an electronic, magnetic, optical, or other physical device that contains or stores executable instructions 122, 124. Thus, the processor 110 may fetch, decode, and execute accessing instructions 122, and bipartite graph mapping instructions 124, each described in further detail below.

The workforce allocation system 100 includes an input function 130 in communication with the accessing instruction 122 to introduce input data. The input data used in the workforce allocation plan may include resource data that describes a number of employee resources. An employee resource may be any person, service, object, commodity, or other entity to be matched to a corresponding demand. For example, when the workforce allocation plan relates to a workforce allocation problem, the resource data may identify a number of employees and their qualifications for specific jobs or tasks. Other suitable sets of resource data will be apparent to those of skill in the art depending on the particular problem to be solved.

The input data may also include demand data describing a set of opportunities that represent the demand for the employee resources. A demand may be any need that may be fulfilled by a corresponding employee resource. Referring again to an example of a workforce allocation plan, the demand data may identify specific jobs or tasks for which employees are needed and a number of employees needed for each job or task. Again, corresponding demand data will be apparent to those of skill in the art depending on the particular problem to be solved.

In one embodiment, the demand data may include a number of jobs needed by a project opportunity, a duration for a job needed by the project opportunity, a set of skills associated with a job of the project opportunity, and so on. In one embodiment, the set of skills includes a job management level, a job proficiency, an industry type, a job skill set, a job title, and so on. The demand data may be used as a cost in an equation to be solved for a minimum cost. The demand data may also be used as a constraint for a variable. Thus, the demand data may describe values or constraints in a set of equations used in the workforce allocation plan.

Lastly, the input data may further include the user's resource preferences. Again, the users resource preferences or pre-allocation preferences, are the employee resources a user or manager would prefer to be assigned to a task or demand for the employee resource.

In the example, mapping instructions 124 may create a graph that contains two sets of nodes, one set that corresponds to the employee resources and another set that corresponds to the set of opportunities that represent demands for employee resources or demand instances. Mapping instructions 124 may then create multiple edges, with each edge extending between a node in the set of employee resources and a node in the set of demand instances. Each of the created edges may represent a potential allocation of an employee resource to a corresponding demand instance that may be satisfied by that employee resource. In other words, each demand instance may be expressed as either satisfied or not and mapping instructions 124 may create an edge for each such instance.

In addition, in some embodiments, mapping instructions 124 may assign a cost to each edge in the bipartite graph. Such a cost may be based on a plurality of predetermined constants, with one or more constants used for each edge. For example, when the graph relates to assignment of a particular employee to a given job, the costs for an edge may be proportionate to a cost of assigning an employee, a cost of training the employee, if necessary, and the like.

During the example mapping, the Resources/Positions (RP) instance is transformed into a feasible symmetric instance of the assignment problem, given by a bipartite graph G=(X∪Y,E) and the cost function c:E→Z, where X represents the resources, Y represents the positions and E represents the set of feasible pairs {resource,position}, with n=|X|=|Y|. Thus, considering the pre-allocated pairs Mₚᵣₑ⊂E, the objective is to find an optimal solution Mₛₒₗ⊂E, expressing the user's resource preferences, that maximizes |Mₛₒₗ∩Mₚᵣₑ|, i.e. finds an optimal solution that respects the maximum number of the user's resource preferences. In the example, to achieve the optimal solution, an ε-scaling auction model is used to get a perfect matching M and a price vector (price function) p_{Y}:Y→R that satisfy the ε-complementary slackness condition, for some ε≦1/n². Using the given matching M, the given price vector p_{Y} and the given ε, the sub-graph G_{ε}(M,p_{Y})=(X∪Y, E_{ε}) is constructed with an associated cost function cₚᵣₑ. The associated cost function cₚᵣₑ is a function from the edges {0,−1}, with 0 for non-preallocated edges and 1 for preallocated edges. The ε-scaling auction model is further used to find a perfect matching Mₛₒₗ of minimum cost in the instance {G_{ε}(M,p_{Y}), cₚᵣₑ}. The perfect matching Mₛₒₗ is the solution to the pre-allocation problem in graph form.

After mapping instructions 124 have created a bipartite graph and assigned any associated costs, any of a number of methods may be used to find a minimum-cost (or maximum-cost) matching for the graph, which may comprise a plurality of edges without common vertices. Examples of suitable methods include the Kuhn-Munkres Algorithm (or Hungarian method), the simplex method or interior point method to solve Linear Programming problems genetic algorithms, or any other method for solving such problems.

In the example, a pre-allocation mathematical model, that expresses a user's resource preferences as to which of its employee resources are preferred to perform a particular task, may be factored into the workforce allocation plan. The mathematical model will consider all the subjective information and utilize the user's resource preferences if the preferences do not violate any of the conditions of the optimization model. That is, the workforce allocation plan would have to allow for an employee to perform a given task in order to take into account the user's resource preferences. If an employee does not meet requirements or constraints to perform a given task, they will not be assigned that task even if the user prefers that the employee is assigned the task. If two workers are equally qualified to perform a particular task, the user's resource preferences will be factored into determining the optimal workforce allocation plan and the user's resource preference will be assigned the given task or demand.

FIG. 2 illustrates an example process for to capture a user's resource preferences in a RP optimization engine 200. The RP optimization engine 200 of FIG. 2 corresponds to a workforce allocation system 100, as shown in FIG. 1, and may include a processor and machine readable storage medium. The example RP optimization engine 200 receives input or resource data in the form of user's resource preferences for employee resources or human judgment 232, 234, demand data or matching criteria 236, and demand for the employee resources or demand and supply information 238.

The matching criteria 236 encapsulated in the objective function of the RP Optimization Engine 200 may not produce a solution due to multiple workforce allocations that satisfy the known constrains. Therefore, there is a need to include a mechanism that can help to extend constraints to aim the optimization to minimize the number of optimal solutions determined by including user's resource preferences.

The comparison of the first and second sets of employee resource pairings to provide the workforce allocation plan having an optimal solution with the maximum number of the user's resource preferences may result in a gap in the workforce allocation plan. A gap is defined as the demand for the employee resource having no employee resource allocated thereto. The workforce allocation plan may be modified to account for the gap by using the user's resource preferences 234 to reassign the employee resources to the set of opportunities that represent the demand for the employee resources to fill the gap. That is, the example further allows for unfilled positions due to data incompleteness to be filled following a reallocation of available employee resources based on a user's resource preferences. The workforce allocation plan may find shortages of employee resource capacity due to availability or qualifications. For example, the employee resources may be allocated to other positions with higher priority, or the employee resources are not available during the dates needed. When there are specific project and manager needs, those needs have to be addressed in the workforce allocation plan. Therefore, the optimal solution should reflect these requirements as additional constraints and the solution can be totally different.

In this sense, the workforce allocation plan has included a mechanism in which the objective function can give prioritization of managers allocations considered as “critical allocations”. For example, considering that Resources={A, B}, and Positions={p1, p2, p3}. After running the optimization with a set of pre-defined and standardized constraints, the RP optimization engine found two optimal solutions with gaps: [{A-p1, B-p2, gap-p3}, and {B-p1, A-p2, gap-p3}]. With this information, the optimization has found gap for p3 and there is not enough information to identify how to fulfill a gap. Using the critical allocation mechanism the resource A is allocated to P3 by the user or manager, then optimal solution can change to {Gap-p1, B-p2, A-p3} or {B-p1, Gap-p2, A-p3}.

FIG. 3 illustrates an example process to capture a user's resource or pre-allocation preferences in a RP optimization engine 300. The RP optimization engine 300 of FIG. 3 corresponds to the RP optimization engine 200 of FIG. 2 and the workforce allocation system 100, as shown in FIG. 1, and may include a processor and machine readable storage medium. The RP optimization engine 300 uses the user's resource preferences in the form of a pre-allocation mathematical model 332 to identify the tradeoffs of assigning the suggested employee resources and to determine if the user's resource preferences are suitable as the optimal workforce allocations.

If the optimal solution is found, the optimization engine can produce a solution that satisfies both optimality and user input. In an example, the input includes Resources={A, B, C} and Positions={p1, p2, p3}. After running the RP optimization engine with a set of pre-defined and standardized constraints, the RP optimization engine found two symmetric optimal solutions: [{A-p1, B-p2, C-p3}, and {B-p1, A-p2, C-p3}]. In the example solution, resource A can be equally allocated to p1 or p2 and the optimal allocation is not impacted. The new mechanism includes the user's resource preferences defined as Pre-allocation={A-p1, B-p3}, which helps to discriminate the possible solutions. Since the user's resource preference fits within the found solutions, the RP optimization engine generates an optimal solution={A-p1, B-p2, C-p3}. This solution is generated automatically for the user to capture the user's resource preferences but at the same time preserve the optimal solution. While the optimal solution contains a maximum number of preferences, it may be the case that none or not all the user's resource preferences can be represented in an optimal solution. For example, if an employee does not meet requirements or constraints of the predetermined resource preferences to perform a given task, they will not be assigned that task even if the user prefers that the employee is assigned the task.

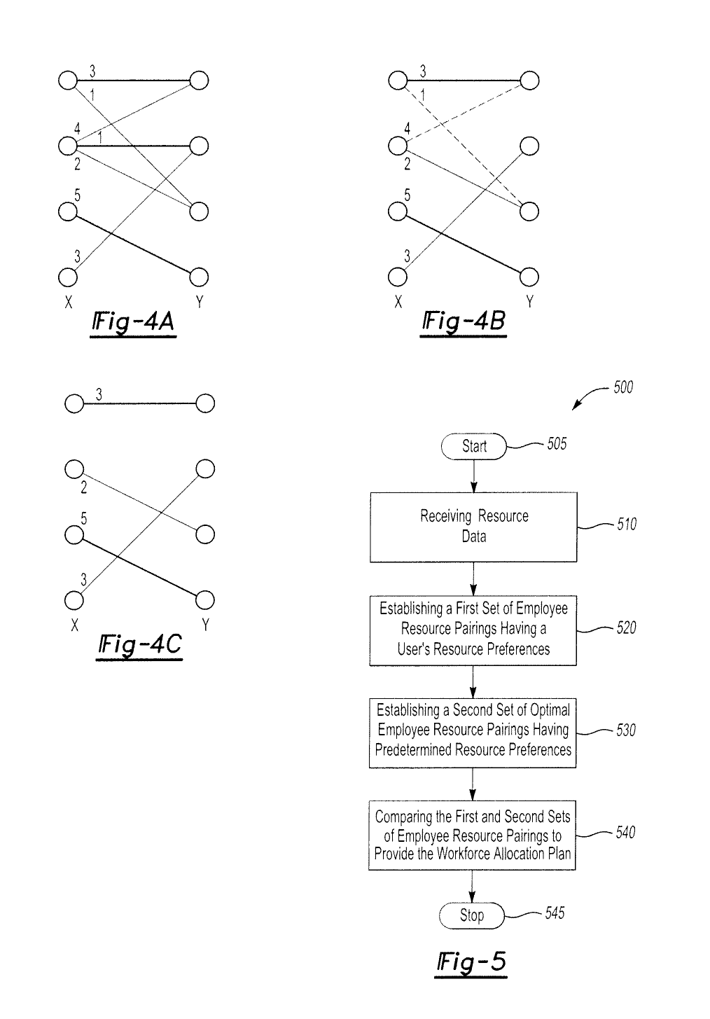

FIGS. 4a-c shows a series of biparite graphs. FIG. 4a is an example first bipartite graph that illustrates a first set of employee resource pairings having a user's resource or pre-allocation preferences to allocate employee resources to demands for the employee resources. FIG. 4a shows an instance of the assignment problem with user's resource preferences given by the thick edges. The first bipartite graph includes a plurality of allocation nodes. A set of first allocation nodes that correspond to the employee resources are disposed along the left side of the graph. A set of second allocation nodes that correspond to the set of opportunities that represent the demand for the employee resources are disposed along the right side of the graph. A plurality of pre-allocation edges extend between one of the first allocation nodes and one of the second allocation nodes to indicate the user's resource preferences for assigning the employee resources to the set of opportunities that represent the demand for the employee resources. In addition, the edges may be numbered to associate a cost for assigning the employee resource to the demand for the employee resource.

FIG. 4b is an example second bipartite graph that illustrates a second set of employee resource pairings having predetermined resource preferences to optimize allocations of employee resources to demands for the employee resources, with each of the resource pairings belonging to an optimal solution. FIG. 4b shows a sub-graph that contains all the optimum perfect matching of the instance. Using the predetermined constraints and variables, the second set of employee resource pairings is determined and includes each of the potential optimal solutions. That is, the second bipartite graph includes all employee resource pairings that belong to an optimal solution. The second bipartite graph includes a plurality of predetermined nodes. A set of first predetermined nodes that correspond to the employee resources are disposed along the left side of the graph. A set of second predetermined nodes that correspond to the set of opportunities that represent the demand for the employee resources are disposed along the right side of the graph. A plurality of predetermined edges extend between one of the first predetermined nodes and one of the second predetermined nodes to indicate the predetermined resource preferences for assigning the employee resources to the set of opportunities that represent the demand for the employee resources. In addition, each of the groups of predetermined edges define an optimal solution. Similar to above, the edges may be numbered to associate a cost for assigning the employee resource to the demand for the employee resource.

FIG. 4c is an example third bipartite graph that illustrate the workforce allocation plan of a minimum cost having the optimal solution with the maximum number the user's resource preferences. FIG. 4c shows the optimum perfect matching solution with the maximum number of the user's resource preferences. The third bipartite graph includes a plurality of optimization nodes. A set of first optimization nodes that correspond to the employee resources are disposed along the left side of the graph. A set of second optimization nodes that correspond to the set of opportunities that represent the demand for the employee resources are disposed along the right side of the graph. A plurality of optimization edges extend between one of the first optimization nodes and one of the second optimization nodes to indicate the workforce allocation plan having the optimal solution with the maximum number of the user's resource preferences. Similar to above, the edges are numbered to associate a cost for assigning the employee resource to the demand for the employee resource. The edges represent the minimum cost for the optimal solution with the maximum number of user's resource preferences.

FIG. 5 illustrates an example method associated with optimizing allocations in a workforce allocation plan. Although execution of method 500 is described below with reference to the components of workforce allocation system 100, other suitable components for execution of method 500 will be apparent to those of skill in the art. Method 500 may be implemented in the form of executable instructions stored on a machine-readable storage medium, such as machine-readable storage medium 120 of FIG. 1. Method 500 starts at block 505, and proceeds to block 510 where resource data is received. The resource data may include data that relates to employee resources. The employee resources data may include definitions of employee qualifications, existing employee release dates from current projects, employee transitions (e.g. training, promotions, redeployment, etc.), employee locations and travel capabilities, and the like. The resource data may further include data that relates to demand for the employee resources, such as actual demand of ongoing projects being serviced or staffed by the organization, or potential demand of project opportunities. The demand for employee resources data may include data that relates to priority of ongoing and potential projects, opportunity cost data such as a number of jobs associated with each opportunity, start and end times for ongoing and potential jobs, job staffing and skill requirements, job locations, and so forth. Skill requirements for jobs may specify needed management level, industry type, skill type, skill set, skill proficiencies, and so forth.

Lastly, the input data may further include the user's resource preferences. Again, the user's resource preferences or pre-allocation preferences, are the employee resources a user or manager would prefer to be assigned to a task or demand for the employee resource.

After receipt of the resource data, method 500 may then proceed to block 520, where a first set of employee resource pairings is established using the user's resource preferences to assign the employee resources to the set of opportunities that represent the demand for the employee resources. The first set of employee resource pairings is mapped to the first bipartite graph, as shown in FIG. 4a, that defines the user's resource preferences to assign the employee resources to the set of opportunities that represent the demand for the employee resources. The mapping of the first bipartite graph includes creating the pre-allocation edge to each allocation node in the set of second allocation nodes from each allocation node in the set of first allocation nodes to indicate the user's resource preferences for assigning the employee resources to the set of opportunities that represent the demand for the employee resources. A pre-allocation cost may be assigned to each of the pre-allocation edges.

After establishing the first set of employee resource pairings, method 500 may proceed to block 530, where a second set of employee resource pairings is established using the predetermined resource preferences to assign the employee resources to the set of opportunities that represent the demand for the employee resources. The second set of all employee resource pairings further defines each of the potential optimal solutions. That is, the second set of employee resource pairings includes all employee resource pairings that belong to an optimal solution. The second set of employee resource pairings is mapped to a second bipartite graph that defines the predetermined resource preferences to assign the employee resources to the set of opportunities that represent the demand for the employee resources and each of the optimal solutions. A predetermined edge extends between each predetermined node in the set of second predetermined nodes and each predetermined node in the set of first predetermined nodes to indicate the workforce allocation plan having the optimal solution with the maximum number of the user's resource preferences. As seen in FIG. 4b, each of the nodes can have multiple predetermined edges that extend therefrom. Each of these predetermined edges represents a potential optimal solution. A predetermined cost may be assigned to each of the predetermined edges.

After establishing the second set of employee resource pairings, method 500 may then proceed to block 540, where the first and second sets of employee resource pairings are compared to provide the workforce allocation plan having the optimal solution with the maximum number of the user's resource preferences. In particular, a third bipartite graph is mapped from the first and second bipartite graphs to provide the workforce allocation plan having the optimal solution with the maximum number of the user's resource preferences. An optimization edge extends between each optimization node in the set of second optimization nodes and each optimization node in the set of first optimization nodes to indicate which of the corresponding employee resources are available for allocation to the demands of the employees resources to satisfy the workforce allocation plan. The optimal cost is determined by assigning the optimal cost to each optimization edge that extends between one of the first optimization nodes and one of the second optimization nodes. Method 500 may then proceed to block 545, where method 500 may stop.

Method 500 may also include, at 540, minimizing a workforce cost. Minimizing a workforce cost at 540 may be performed by solving the objective function in light of the set of cost constraints. Solving the objective function may include optimizing a tradeoff between labor utilization and project demand fulfillment. Minimizing the optimal cost may be achieved by comparing the pre-allocation cost from the first bipartite graph and predetermined cost from the second bipartite graph to provide the workforce allocation plan in the form of the third bipartite graph having the lowest optimal cost.

The embodiment provided herein provides many advantages. The example method provides for multiple optimal solutions for resource-position matching due to missing unique allocation details. The optimization method defines a set of known constraints that will standardize resource planning across business units. These constraints can produce multiple optimal solutions that require human judgment to infer a possible unique solution. The example method takes into account the user's resource preferences thus expanding the vision of optimization as a black-box tool. The example method captures more information that can help to discriminate symmetric optimal solutions or non-implemented solutions. In addition, the example method enhances optimal solutions. By adding pre-allocation or user's resource preferences, the optimization can still produce an optimal solution and itself also represents an enhanced solution due to the user input. With this approach, the user can execute their plan aligned to their requirements, and at the same time aligned to the other user requirements helped by the optimization model. In addition, the example method produces feasible solutions that can be implemented by users. By adding critical allocations, the optimization can freeze resources that are key elements for the staffing execution. This information is considered in the optimization model to adjust the optimal solutions that can be implemented by the user and are aligned to the project needs.

We claim:

1. A method for optimizing allocations in a workforce allocation plan, the method comprising:
receiving resource data that includes data relating to employee resources and to a set of opportunities representing a demand for the employee resources;
establishing a first set of employee resource pairings having a user's resource preferences for assigning the employee resources to the demand for the employee resources;
establishing a second set of employee resource pairings having predetermined resource preferences for assigning the employee resources to the demand for the employee resources and defining a plurality of optimal solutions; and
comparing the first and second sets of employee resource pairings to provide the workforce allocation plan having the one of the plurality of optimal solutions with a maximum number of the user's resource preferences for optimizing allocations in the workforce allocation plan.

2. The method as set forth in claim 1 wherein establishing the first set of employee resource pairings comprises mapping the first set of employee resource pairings to a first bipartite graph defining the user's resource preferences for assigning the employee resources to the demand for the employee resources, the first bipartite graph comprising:
a plurality of allocation nodes including;
a set of first allocation nodes corresponding to the employee resources, and
a set of second allocation nodes corresponding to the set of opportunities representing the demand for the employee resources; and
a plurality of pre-allocation edges, with each of the plurality of pre-allocation edges extending between one of the first allocation nodes and one of the second allocation nodes to indicate the user's resource preferences for assigning the employee resources to the demand for the employee resources.

3. The method as set forth in claim 2 wherein mapping the first set of employee resource pairings to the first bipartite graph further comprises:
creating the pre-allocation edge to each allocation node in the set of second allocation nodes from each allocation node in the set of first allocation nodes to indicate the user's resource preferences for assigning the employee resources to the demand for the employee resources.

4. The method as set forth in claim 2 wherein establishing the second set of employee resource pairings comprises mapping the second set of employee resource pairings to a second bipartite graph defining the predetermined resource preferences for assigning the employee resources to the demand for the employee resources and defining the plurality of optimal solutions, the second bipartite graph comprising:
a plurality of predetermined nodes including;
a set of first predetermined nodes corresponding to the employee resources, and
a set of second predetermined nodes corresponding to the set of opportunities representing the demand for the employee resources; and
a plurality of predetermined edges, with each of the plurality of predetermined edges extending between one of the first predetermined nodes and one of the second predetermined nodes to indicate the predetermined resource preferences for assigning the employee resources to the demand for the employee resources and define the plurality of optimal solutions.

5. The method as set forth in claim 4 wherein mapping the second set of employee resource pairings to the second bipartite graph further comprises:
creating the predetermined edge to each predetermined node in the set of second predetermined nodes from each predetermined node in the set of first predetermined nodes to indicate which of the corresponding employee resources is available for allocation to satisfy the corresponding demands for the employee resources and to define each of the plurality of optimal solutions.

6. The method as set forth in claim 4 wherein comparing the first and second set of employee resource pairings comprises mapping a third bipartite graph from the first and second bipartite graphs for providing the workforce allocation plan having the one of the plurality of optimal solutions with the maximum number of the user's resource preferences, the third bipartite graph comprising:
a plurality of optimization nodes including;
a set of first optimization nodes corresponding to the employee resources, and
a set of second optimization nodes corresponding to the set of opportunities representing the demand for the employee resources; and
a plurality of optimization edges, with each of the plurality of optimization edges extending between one of the first optimization nodes and one of the second optimization nodes to indicate the workforce allocation plan having the one of the plurality of optimal solutions with the maximum number of the user's resource preferences.

7. The method as set forth in claim 6 wherein mapping the third bipartite graph further comprises:
creating an optimization edge to each optimization node in the set of second optimization nodes from each optimization node in the set of first optimization nodes to for satisfying the workforce allocation plan having the one of the plurality of optimal solutions with the maximum number of the user's resource preferences.

8. The method as set forth in claim 6 further comprising:
assigning a pre-allocation cost to each of the pre-allocation edges; and
assigning a predetermined cost to each of the predetermined edges.

9. The method as set forth in claim 8 further comprising:
determining an optimal cost by assigning the optimal cost to each optimization edge extending between one of the first optimization nodes and one of the second optimization nodes to indicate the workforce allocation plan having the one of the plurality of optimal solutions with the maximum number of the user's resource preferences.

10. The method as set forth in claim 9 further comprising:
minimizing the optimal cost by comparing the pre-allocation cost from the first bipartite graph and predetermined cost from the second bipartite graph to provide the workforce allocation plan in the form of the third bipartite graph having the lowest optimal cost with the maximum number of the user's resource preferences.

11. The method as set forth in claim 1 wherein comparing the first and second sets of employee resource pairings to provide the workforce allocation plan having the one of the plurality of optimal solutions with the maximum number of the user's resource preferences results in a gap in the workforce allocation plan, the gap being the demand for the employee resource having no employee resource allocated thereto, and further comprising:
modifying the workforce allocation plan to account for the gap by using the user's resource preferences for reassigning the employee resources to the set of opportunities representing the demand for the employee resources for filling the gap.

12. A computer-readable storage medium having machine readable instructions that when executed by a processor, cause the processor to:
receive resource data that includes data relating to employee resources and to a set of opportunities representing a demand for the employee resources;
establish a first set of employee resource pairings having a user's resource preferences for assigning the employee resources to the demand for the employee resources;
establish a second set of employee resource pairings having predetermined resource preferences for assigning the employee resources to the demand for the employee resources and defining a plurality of optimal solutions; and
compare the first and second sets of employee resource pairings to provide the workforce allocation plan having the one of the plurality of optimal solutions with a maximum number of the user's resource preferences for optimizing allocations in the workforce allocation plan.

13. The computer-readable storage medium as set forth in claim 12 further having machine readable instructions that when executed by a processor, cause the processor to map the first set of employee resource pairings to a first bipartite graph that defines the user's resource preferences for assigning the employee resources to the demand for the employee resources.

14. The computer-readable storage medium as set forth in claim 13 further having machine readable instructions that when executed by a processor, cause the processor to map the second set of employee resource pairings to a second bipartite graph that defines the predetermined resource preferences for assigning the employee resources to the demand for the employee resources and that defines the plurality of optimal solutions.

15. The computer-readable storage medium as set forth in claim 14 further having machine readable instructions that when executed by a processor cause the processor to map a third bipartite graph from the first and second bipartite graphs to provide the workforce allocation plan having the one of the plurality of optimal solutions with the maximum number of the user's resource preferences.

16. The computer-readable storage medium as set forth in claim 12 further having machine readable instructions that when executed by a processor, cause the processor to modify the workforce allocation plan to account for a gap by using the user's resource preferences to reassign the employee resources to the set of opportunities representing the demand for the employee resources for filling the gap.

17. A system of optimizing allocations in a workforce allocation plan, comprising:
a data storage subsystem for storing a dataset including resource data having data relating to employee resources and data relating to a set of opportunities representing a demand for the employee resources;
a processing subsystem in communication with the data storage subsystem to:
establish a first set of employee resource pairings having a user's resource preferences for assigning the employee resources to the demand for the employee resources;
establish a second set of employee resource pairings having predetermined resource preferences for assigning the employee resources to the demand for the employee resources and defining a plurality of optimal solutions; and
compare the first and second sets of employee resource pairings to provide the workforce allocation plan having the one of the plurality of optimal solutions with a maximum number of the user's resource preferences for optimizing allocations in the workforce allocation plan.

18. The system as set forth in claim 17 wherein the data storage subsystem further comprises:
instructions for mapping the first set of employee resource pairings to a first bipartite graph defining the user's resource preferences for assigning the employee resources to the demand for the employee resources;
instructions for mapping the second set of employee resource pairings to a second bipartite graph defining the predetermined resource preferences for assigning the employee resources to the demand for the employee resources and defining the plurality of optimal solutions; and
instructions for mapping a third bipartite graph from the first and second bipartite graphs for providing the workforce allocation plan having the one of the plurality of optimal solutions with the maximum number of the user's resource preferences.

19. The system as set forth in claim 18 wherein the third bipartite graph is mapped for providing the workforce allocation plan having a minimal optimal cost by comparing a pre-allocation cost associated with the user's resource preferences in the first bipartite graph and a predetermined cost associated with the predetermined resource preferences in the second bipartite graph to provide the workforce allocation plan in the form of the third bipartite graph having the lowest optimal cost with the maximum number of the user's resource preferences.
